(19) United States
(12) Patent Application Publication
(10) Pub. No.: US 2024/0430828 A1
(43) Pub. Date: Dec. 26, 2024

(54) TIME SYNCHRONIZATION ACROSS WIRELESS DEVICES

(71) Applicant: Samsung Electronics Co., Ltd., Suwon-si (KR)

(72) Inventors: Feng Qi, Richardson, TX (US); Abhishek Sehgal, Frisco, TX (US); Hao Chen, Allen, TX (US); Jianzhong Zhang, Dallas, TX (US)

(21) Appl. No.: 18/590,922

(22) Filed: Feb. 28, 2024

Related U.S. Application Data
(60) Provisional application No. 63/522,990, filed on Jun. 23, 2023.

(51) Int. Cl. H04W 56/00

(52) U.S. Cl. CPC H04W 56/0015

(57) ABSTRACT

A method includes calibrating, at a wireless device, a wireless fidelity (Wi-Fi) chipset-level timer based on a time synchronization function (TSF) frame received from a Wi-Fi access point. The method also includes performing, at the wireless device, a coarse synchronization of a microcontroller-level or CPU-level timer based on the calibrated Wi-Fi chipset-level timer. The method further includes performing, at the wireless device, a fine synchronization of the microcontroller-level or CPU-level timer after the coarse synchronization. The fine synchronization is performed according to a first time scale measured in first time units and the coarse synchronization is performed according to a second time scale measured in second time units that are a multiple of the first time units.

### CROSS-REFERENCE TO RELATED APPLICATION AND CLAIM OF PRIORITY

This application claims priority under 35 U.S.C. § 119(e) to U.S. Provisional Patent Application No. 63/522,990, filed on Jun. 23, 2023, which is hereby incorporated by reference in its entirety.

### TECHNICAL FIELD

This disclosure relates generally to wireless communications systems. Embodiments of this disclosure relate to methods and apparatuses for time synchronization across wireless devices.

### BACKGROUND

Event synchronization across multiple wireless platforms can enhance synchronization performance and help remove cables for media applications, like televisions, soundbars, and video walls. Wireless setups provide obvious benefits, such as reducing costs on equipment connection and enhancing flexibility of equipment setup. Also, when a media product is equipped such that wireless-fidelity (Wi-Fi) handles all signals and a wireless power pad handles all power, such a media product can be easily made waterproof for outdoor usage.

### SUMMARY

Embodiments of the present disclosure provide methods and apparatuses for time synchronization across wireless devices.

In one embodiment, a method includes calibrating, at a wireless device, a Wi-Fi chipset-level timer based on a time synchronization function (TSF) frame received from a Wi-Fi access point. The method also includes performing, at the wireless device, a coarse synchronization of a microcontroller-level or CPU-level timer based on the calibrated Wi-Fi chipset-level timer. The method further includes performing, at the wireless device, a fine synchronization of the microcontroller-level or CPU-level timer after the coarse synchronization. The fine synchronization is performed according to a first time scale measured in first time units and the coarse synchronization is performed according to a second time scale measured in second time units that are a multiple of the first time units.

In another embodiment, a device includes a transceiver and a processor operably connected to the transceiver. The processor is configured to: calibrate a Wi-Fi chipset-level timer based on a TSF frame received from a Wi-Fi access point; perform a coarse synchronization of a microcontroller-level or CPU-level timer based on the calibrated Wi-Fi chipset-level timer; and perform a fine synchronization of the microcontroller-level or CPU-level timer after the coarse synchronization. The processor is configured to perform the fine synchronization according to a first time scale measured in first time units and perform the coarse synchronization according to a second time scale measured in second time units that are a multiple of the first time units.

In another embodiment, a non-transitory computer readable medium includes program code that, when executed by a processor of a device, causes the device to: calibrate a Wi-Fi chipset-level timer based on a TSF frame received from a Wi-Fi access point; perform a coarse synchronization of a microcontroller-level or CPU-level timer based on the calibrated Wi-Fi chipset-level timer; and perform a fine synchronization of the microcontroller-level or CPU-level timer after the coarse synchronization. The program code causes the device to perform the fine synchronization according to a first time scale measured in first time units and perform the coarse synchronization according to a second time scale measured in second time units that are a multiple of the first time units.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example system in which time synchronization across wireless devices can be performed according to various embodiments of the present disclosure;

FIG. 4 illustrates an example technique for synchronizing the microcontroller or CPU time using user datagram protocol (UDP) packets according to various embodiments of the present disclosure;

FIGS. 5 and 6 illustrate an example technique for synchronizing the microcontroller or CPU time using a TSF register according to various embodiments of the present disclosure;

FIG. 7 illustrates an example process for hierarchical synchronization of a microcontroller or CPU time according to various embodiments of the present disclosure;

FIG. 8 illustrates another example process for hierarchical synchronization of a microcontroller or CPU time according to various embodiments of the present disclosure;

FIGS. 9 through 11 illustrate block diagrams showing further details of operations performed in the process of FIG. 8 according to various embodiments of the present disclosure;

FIG. 12 illustrates an example workflow diagram of a wireless event synchronization process using two devices according to various embodiments of the present disclosure; and

FIG. 13 illustrates a flow chart of a method for time synchronization across wireless devices according to various embodiments of the present disclosure.

### DETAILED DESCRIPTION

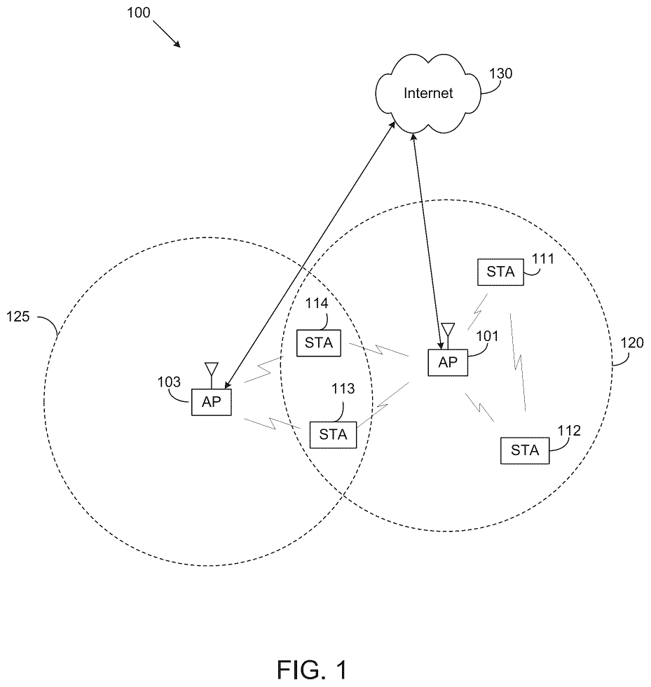

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable time synchronization across wireless devices. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

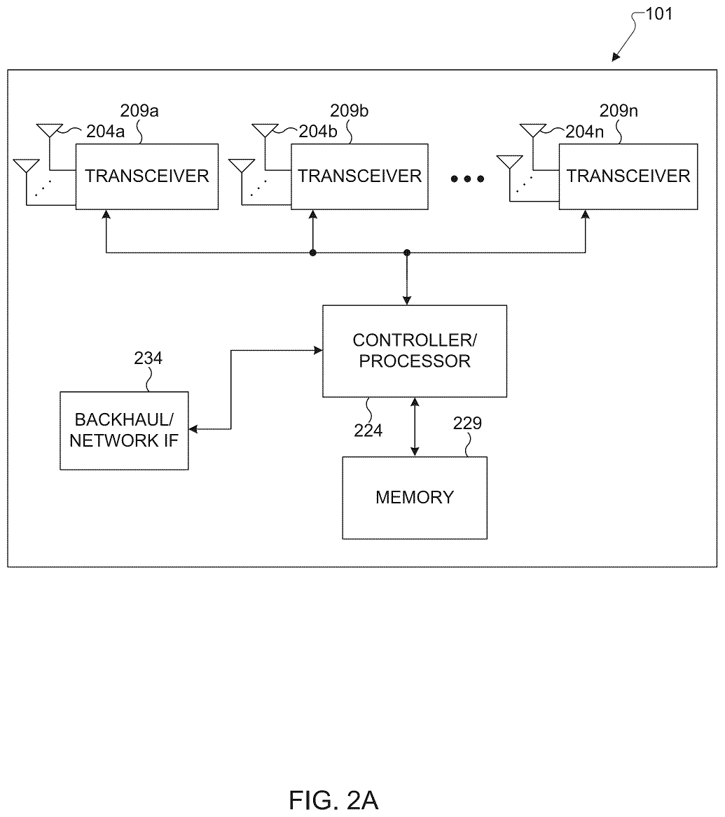

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including time synchronization across wireless devices. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for time synchronization across wireless devices. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable time synchronization across wireless devices. In some embodiments, the processor 240 includes at least one microprocessor or microcontroller.

The processor 240 is also capable of executing other processes and programs resident in the memory 260, such as operations for enabling time synchronization across wireless devices. The processor 240 can move data into or out of the memory 260 as required by an executing process. In some embodiments, the processor 240 is configured to execute a plurality of applications 262, such as applications to enable time synchronization across wireless devices. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As discussed earlier, event synchronization across multiple wireless platforms can enhance synchronization performance and help remove cables for media applications, like televisions, soundbars, and video walls. Wireless setups provide obvious benefits, such as reducing costs on equipment connection and enhancing flexibility of equipment setup. Also, when a media product is equipped such that Wi-Fi handles all signals and a wireless power pad handles all power, such a media product can be easily made waterproof for outdoor usage.

Recent Wi-Fi developments have enabled use of a Time Synchronization Function (TSF) clock. However, event and time synchronization requires more than just a synchronized clock. It is important to manage the latencies created by wireless platforms. For example, there are latencies from getting a synchronized clock time, scheduling target events, and triggering target events. Currently, although Wi-Fi modules are synchronized with a dedicated clock, the clock does not have an inherent trigger mechanism to properly handle latencies and synchronize events on main processors and other modules across multiple System-on-Chips (SoCs).

To address these and other issues, this disclosure provides systems and methods for time synchronization across wireless devices. As described in more detail below, the disclosed embodiments can achieve accurate event and time synchronization through Wi-Fi TSF clocks. At a high level, the disclosed embodiments include a two-step approach to enable accurate event synchronization. The steps include (1) a coarse timer synchronization that aligns multiple wireless platforms on a milliseconds scale prior to fine event synchronization, and (2) a fine event synchronization that triggers target events across multiple wireless platforms and reduces misalignments or jittering to the scale of microseconds.

In general, the disclosed embodiments can trigger target events at the required time by manipulating the latencies created by wireless platforms. With this approach, either hardware or software (or a combination of both) could be used to achieve accurate synchronization. The disclosed embodiments enable various applications such as synched audio experience across different devices and the like. Note that while some of the embodiments discussed below are described in the context of Wi-Fi-enabled audio systems—such as televisions, soundbars, and video walls—these are merely examples. It will be understood that the principles of this disclosure may be implemented in any number of other suitable contexts or systems.

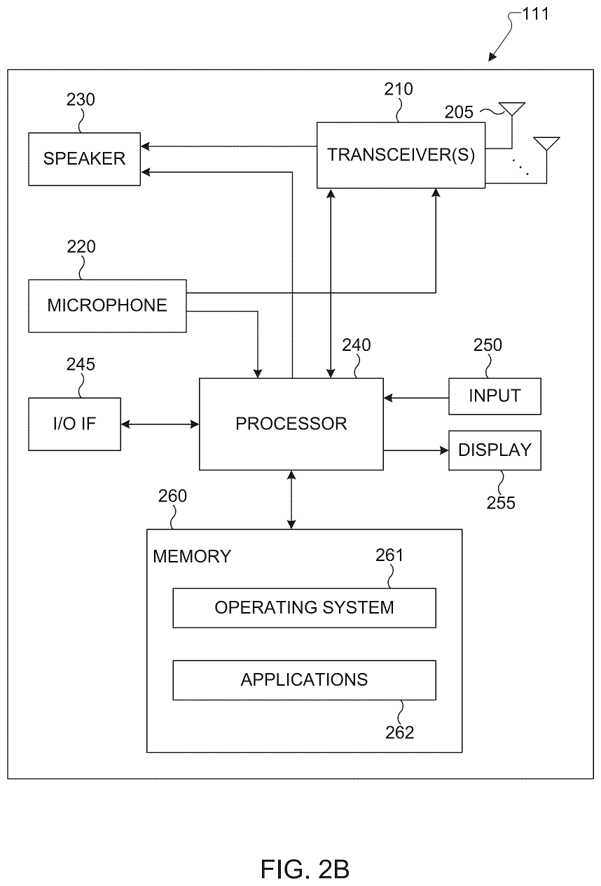

FIG. 3 illustrates an example system 300 in which time synchronization across wireless devices can be performed according to various embodiments of the present disclosure. As shown in FIG. 3, the system 300 includes multiple audio devices 301-303 that communicate with an access point (AP) 310. The audio devices 301-303 are distributed and synchronized by a wireless network. Each audio device 301-303 is a wireless audio device (e.g., a wireless smart speaker, a sound bar, a television, a smart phone, and the like) that includes one or more microcontrollers or CPUs and a Wi-Fi chipset that hosts a TSF timer. In some embodiments, each audio device 301-303 can represent (or be represented by) the STA 111 of FIG. 1. The AP 310 is a wireless AP (e.g., a Wi-Fi router) that is communicatively connected to all of the audio devices 301-303. In some embodiments, the AP 310 can represent (or be represented by) the AP 101 of FIG. 1. It is noted that STAs, APs, and audio devices come in a wide variety of configurations, and FIG. 3 does not limit the scope of this disclosure to any particular implementation. For example, when no AP is available, a STA audio device could be configured as a SoftAP providing TSF frames to other STA audio devices while handling audio synchronization.

In some embodiments, the audio devices 301-303 are configured for synchronized audio service. Synchronized audio service is a feature that allows distributed audio devices, such as the audio devices 301-303, to transmit synchronized audio signals. In some embodiments, the audio devices 301-303 sample at ˜40 kHz; therefore, the time interval between two digital samples is approximately 25 microseconds. In order to achieve distributed beamforming, it is helpful or necessary to synchronize the audio devices 301-303 with low latency (e.g., less than 60 microseconds).

The AP 310 periodically broadcasts beacon signals that include one or more time synchronization function (TSF) frames. Whenever a beacon signal is detected by one of the audio devices 301-303, that audio device 301-303 can use the TSF frame to calibrate the TSF timer inside the Wi-Fi chipset. Once the chipset time is synchronized, there are several different ways to synchronize the microcontroller or CPU of the audio device 301-303.

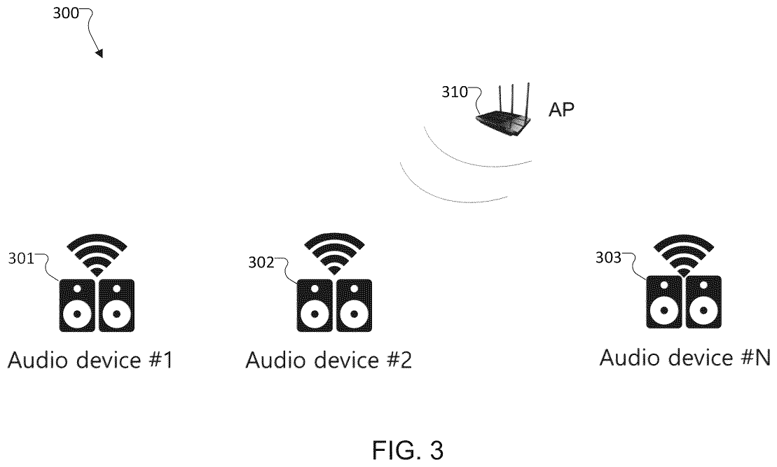

FIG. 4 illustrates an example technique 400 for synchronizing the microcontroller or CPU time using user datagram protocol (UDP) packets according to various embodiments of the present disclosure. The embodiment of the technique 400 shown in FIG. 4 is for illustration only. Other embodiments of the technique 400 could be used without departing from the scope of this disclosure. For ease of explanation, the technique 400 will be described as being implemented in the audio devices 301-303 of FIG. 3. However, the technique 400 could be implemented in any other suitable network or system.

As shown in FIG. 4, each of the audio devices 301-303 includes a Wi-Fi chipset 405 and at least one speaker 410 that are communicatively coupled to a CPU or microcontroller operating system (OS) 415 (such as an Android OS). The Wi-Fi chipset 405 can include an upper MAC layer 420 and a lower MAC layer 425.

Whenever a beacon from the AP 310 is received by the Wi-Fi chipset 405, a UDP packet 430 with a TSF time is sent from the upper MAC layer 420 to the OS 415. Once the OS 415 receives the UDP packet 430, the OS 415 takes note of the OS time t_{local} and the received TSF time t_{global}ⁱ. Since every audio device 301-303 is supposed to receive the beacon at the same time, the received TSF time will be treated as global time. The audio device 301-303 can conduct a regression operation to calibrate the local CPU time to global time, such as by the following:

$${t}_{global}^{i} = {a}_{i} * {t}_{local} + {b}_{i}$$

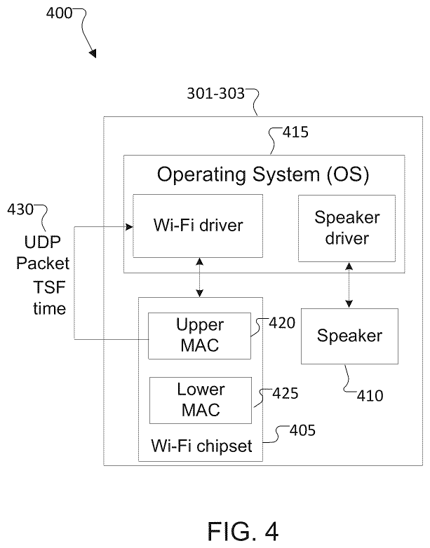

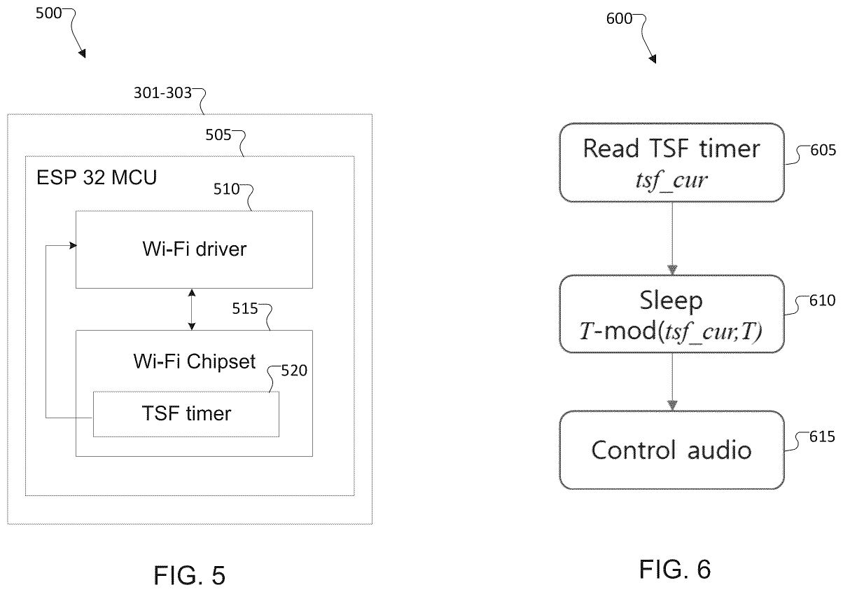

FIGS. 5 and 6 illustrate an example technique 500 for synchronizing the microcontroller or CPU time using a TSF register according to various embodiments of the present disclosure. Specifically, FIG. 5 illustrates components of the technique 500, while FIG. 6 illustrates a flowchart 600 showing the operations of the technique 500. The embodiment of the technique 500 shown in FIGS. 5 and 6 is for illustration only. Other embodiments of the technique 500 could be used without departing from the scope of this disclosure. For ease of explanation, the technique 500 will be described as being implemented in the audio devices 301-303 of FIG. 3. However, the technique 500 could be implemented in any other suitable network or system.

As shown in FIGS. 5 and 6, each of the audio devices 301-303 include a microcontroller unit (MCU) 505 or CPU, which can be, for example, a SoC MCU. The MCU 505 can include a Wi-Fi driver 510 and a Wi-Fi chipset 515. The Wi-Fi chipset 515 operates a TSF timer 520. Each of the audio devices 301-303 can achieve CPU or MCU synchronization by using a register reading function call designed for the Wi-Fi driver 510. This function call could allow the MCU 505 to read the instant register information of the TSF timer 520. In this case, the MCU 505 does not need to wait for beacon packets to read the TSF timer 520. Using the technique 500, synchronization among the audio devices 301-303 could be achieved by synchronizing each audio device 301-303 to its own TSF timer 520. As shown in FIG. 6, at operation 605, every T seconds, a control command is sent to the audio devices 301-303. This causes each audio device 301-303 to read its TSF timer 520. Let tsf_cur be the current time of the TSF timer 520 when read from the register reading function call. At operation 610, the MCU 505 is asked to sleep for T−mod(tsf_cur, T) seconds. At operation 615, at the end of the sleep period, the audio device 301-303 controls its audio.

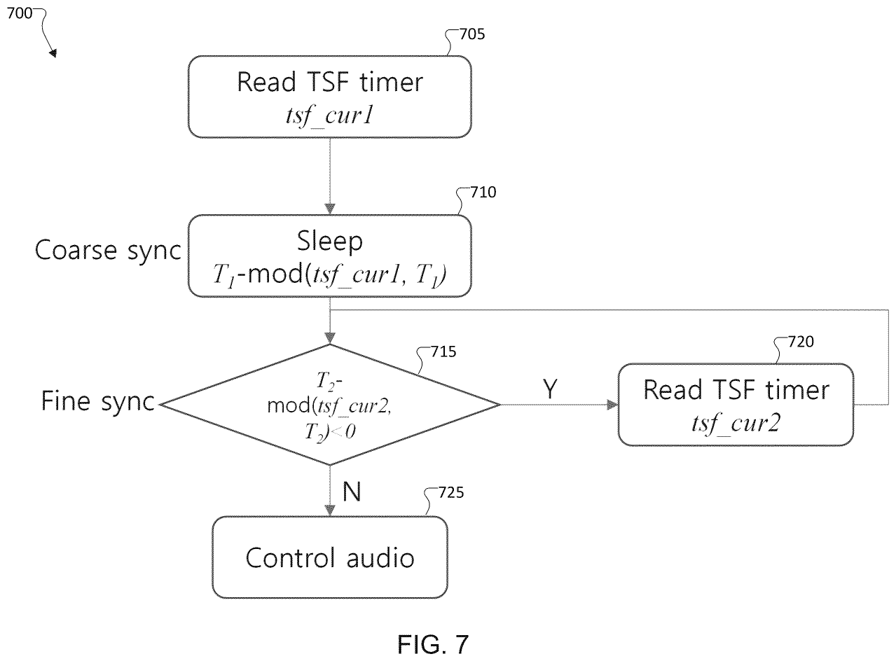

In some implementations, the jitter present in the sleep function could cause an error (for example, an error of approximately 500 microseconds), which can be more than the permissible system error requirement. It is possible to consider this jitter timing error during synchronization. For example, a two-step hierarchical synchronization solution can be implemented to address the jitter, such as described in FIG. 7 below.

FIG. 7 illustrates an example process 700 for hierarchical synchronization of a microcontroller or CPU time according to various embodiments of the present disclosure. The process 700 can be performed to achieve greater accuracy in synchronization. The embodiment of the process 700 shown in FIG. 7 is for illustration only. Other embodiments of the process 700 could be used without departing from the scope of this disclosure. For ease of explanation, the process 700 will be described as being implemented in the audio device 301 of FIG. 3. However, the process 700 could be implemented in any other suitable device or system (such as the audio devices 302 and 303).

As shown in FIG. 7, the process 700 includes both coarse synchronization and fine synchronization operations. At operation 705, the audio device 301 reads the TSF timer 520 in the Wi-Fi chipset 515. Let tsf_cur1 be the current time of the TSF timer 520. In some embodiments, the TSF timer 520 has been calibrated based on a TSF frame received from the AP 310, such as described above.

At operation 710, the audio device 301 performs a one-time coarse synchronization to synchronize a microcontroller-level or CPU-level timer based on the TSF timer 520. The coarse synchronization operation 710 is based on the initial reading of the TSF timer 520 (from operation 705) and a sleep function. For example, the microcontroller or CPU (e.g., the MCU 505) is instructed to sleep for T₁−mod(tsf_cur1, T₁) seconds, where T₁ is the time period for how often the coarse synchronization operation 710 is performed. The coarse synchronization operation 710 can achieve a coarse synchronization accuracy of approximately 500 microseconds.

After the coarse synchronization operation 710, the audio device 301 performs a fine synchronization that includes operations 715 and 720 in an iterative algorithm, such as a while loop. In the while loop, the CPU continuously reads the TSF timer 520 until a period T₂ is achieved. Here, T₂ represents the time period for how often the while loop is performed in the fine synchronization. Let tsf_cur2 be the new current time of the TSF timer 520. In operation 715, the audio device 301 compares the current time to T₂. For example, in operation 715, it is determined if T₂−mod(tsf_{cur2}, T₂)<0. If this is true, the CPU reads the TSF timer 520 again to get the new current time tsf_cur2. If false, then the synchronization is complete, and the audio device 301 can control audio at operation 725. The fine synchronization further improves the synchronization accuracy to ±10 microseconds. Thus, as described, the process 700 can be performed to achieve a 10 microsecond latency. Also, the process 700 can reduce the CPU overhead for synchronization at low latency.

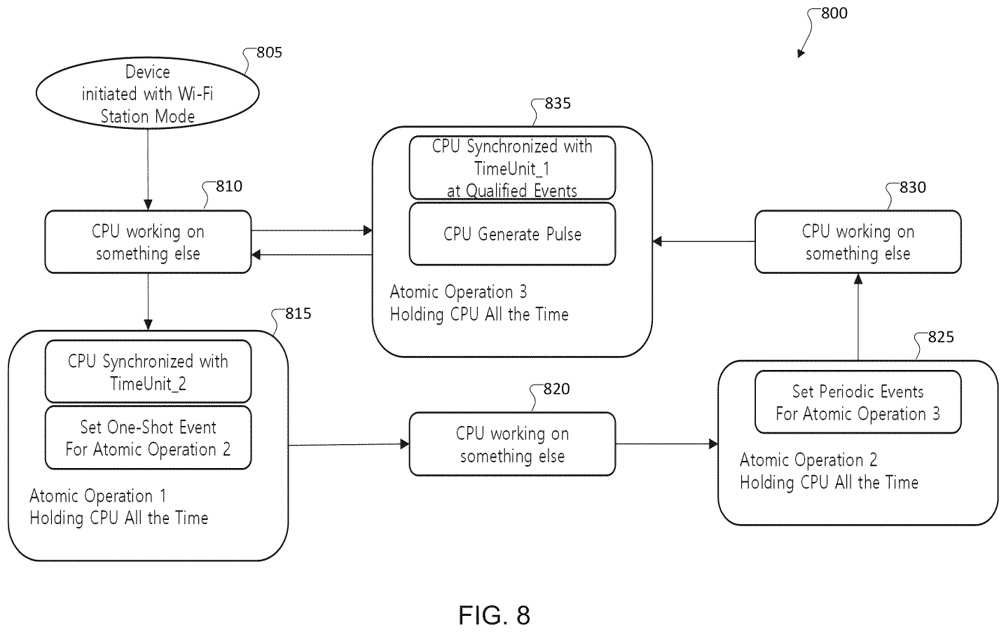

FIG. 8 illustrates another example process 800 for hierarchical synchronization of a microcontroller or CPU time according to various embodiments of the present disclosure. The process 800 can be considered a more detailed version of the process 700 of FIG. 7, and can be performed to achieve greater accuracy in synchronization. The embodiment of the process 800 shown in FIG. 8 is for illustration only. Other embodiments of the process 800 could be used without departing from the scope of this disclosure. For ease of explanation, the process 800 will be described as being implemented in the audio device 301 of FIG. 3. However, the process 800 could be implemented in any other suitable device or system (such as the audio devices 302 and 303).

The software architecture used to perform the process 800 can be independent from operation systems and SoCs. The implementation of the process 800 can be effective as long as the conditions shown below in List 1 are met.

### List 1

Clocks that are capable of the Wi-Fi Time Synchronization Function, called TSF Clock.
APIs that read the TSF Clock with execution time on Time Scale 1 having TimeUnit_1.
Timers capable of triggering one-shot and periodic events with a resolution of TimeUnit_1 and a range greater than Time Scale 2 having TimeUnit_2.
Locking methods allowing critical logic to be executed as atomic operations without interruption. Here, “atomic operation” refers to a set of steps or operations that are performed together by a CPU without interruption or without the CPU performing other simultaneous operations. In other words, during an atomic operation, the CPU only performs the atomic operation and does not perform other operations.

In List 1, there are 2 time scales—Time Scale 1 and Time Scale 2—with different time units, TimeUnit_1 and TimeUnit_2. The different time units represent different scales of elapsed time. In the examples described below, the Time Scale 1 and TimeUnit_1 represent microseconds, while Time Scale 2 and TimeUnit_2 represent milliseconds. Time Scale 1 and Time Scale 2 enable event synchronization on the scale of microseconds to be created. However, other time scales are possible and within the scope of this disclosure. Also, the concept could be expanded to multiple levels of synchronization. For example, time units could be cascaded and expanded to achieve synchronization at different levels, like 1 μs, 1 ms, 1 s, and so on, or 5 μs, 5 ms, 5 s, and so on. In general, the following can be observed:

TimeUnit_1=the time unit of the TSF Clock

TimeUnit_2=TimeUnit_1×UnitCnt_2

. . .

TimeUnit_N=TimeUnit_(N−1)×UnitCnt_N

Here, UnitCnt_2, . . . , UnitCnt_N represent integer multipliers (e.g., 1000) to scale between the time units (e.g., microseconds to milliseconds or milliseconds to seconds). The selection of each time unit should be greater that the jitter caused by the timer and trigger mechanism on that time scale.

The process 800 can be summarized as comprising two main steps. The first step is a coarse synchronization to synchronize local timers with the TSF Clock on Time Scale 1 (e.g., a milliseconds scale) with atomic operations 1 and 2, and part of atomic operation 3. The second step is a fine synchronization to trigger target events with a lumped compensation for previous latencies on Time Scale 2 (e.g., hundreds of microseconds scale) in part of atomic operation 3. It is important for accurate event synchronization to allow the atomic operations to hold the CPU without interruption. Outside of the atomic operations, while timers are running in the background, the CPU is free to work on other tasks.

As shown in FIG. 8, at operation 805, the SoC of the audio device 301 is initiated with Wi-Fi Station mode. Once initiated, the Wi-Fi module of the SoC starts receiving beacons, synchronizing with the AP 310, and making the TSF Clock available. After initiation, at operation 810, the CPU can work on other tasks until it is time for operation 815, which includes atomic operation 1.

At operation 815, the audio device 301 performs atomic operation 1 to achieve timer synchronization. During atomic operation 1, the audio device 301 captures TSF Clock values and calculates a delay to configure timers for Time Scale 2 alignment across multiple wireless platforms. The execution of atomic operation 1 is set with an interval greater than the Wi-Fi beacon interval for TSF Clock synchronization.

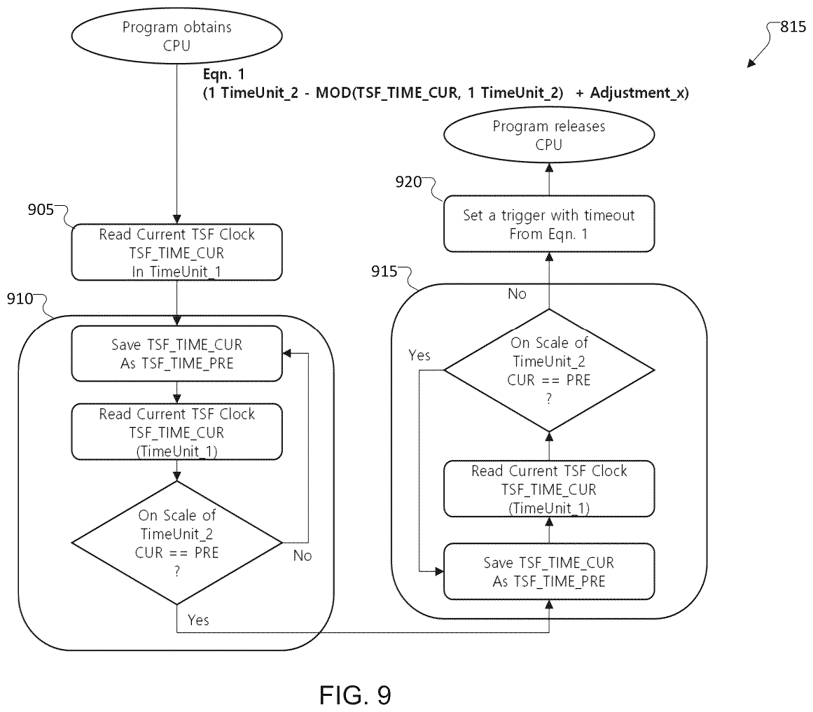

FIG. 9 illustrates a block diagram showing further details of operation 815 according to various embodiments of the present disclosure. As shown in FIG. 9, atomic operation 1 includes step 905, in which the audio device 301 reads the current TSF clock in TimeUnit_1 as TSF_TIME_CUR.

At step 910, the audio device 301 reads the current TSF clock in TimeUnit_1 and keeps the previous reading as TSF_TIME_PRE in a loop until TSF_TIME_CUR is equal to TSF_TIME_PREV at a scale of TimeUnit_2. It is noted that in some implementations, step 910 is optional.

At step 915, the audio device 301 reads the current TSF clock in TimeUnit_1 and keeps the previous reading as TSF_TIME_PRE in a loop until TSF_TIME_CUR is not equal to TSF_TIME_PREV at a scale of TimeUnit_2. At this point, MOD(TSF_TIME_CUR, 1 TimeUnit_2) is close to 0, and there is enough time to complete step 920.

At step 920, the audio device 301 sets a trigger from a one-shot timer with a timeout equal to (1 TimeUnit_2−MOD(TSF_TIME_CUR, 1 TimeUnit_2)+Adjustment_x).

After completion of atomic operation 1, at operation 820, the CPU can work on other tasks until it is time for operation 825, which includes atomic operation 2.

At operation 825, the audio device 301 performs atomic operation 2 to achieve event synchronization. Atomic operation 2 is the second operation in the coarse synchronization to synchronize local timers. Atomic operation 2 sets the period of a periodic timer to generate callbacks on the milliseconds scale at the timeout event of the one-shot timer. The execution of atomic operation 2 follows the execution of atomic operation 1.

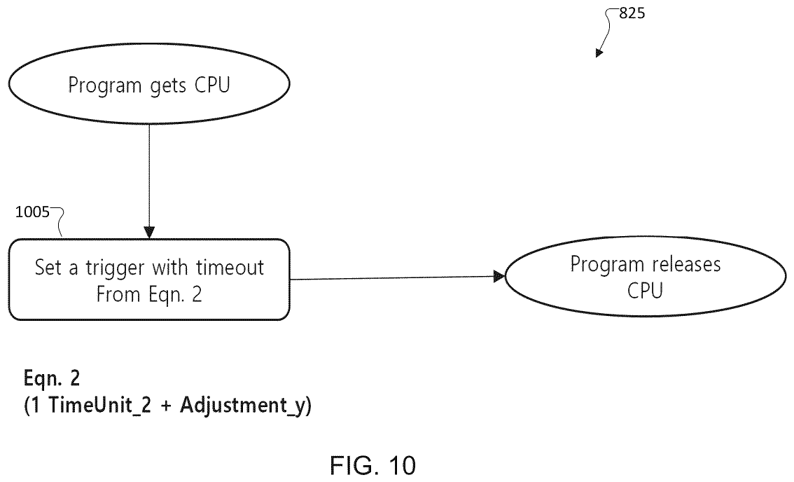

FIG. 10 illustrates a block diagram showing further details of operation 825 according to various embodiments of the present disclosure. As shown in FIG. 10, atomic operation 2 includes step 1005, in which the audio device 301 starts or restarts a trigger from the periodic timer with a timeout of (TimeUnit_2+Adjustment_y).

After completion of atomic operation 2, at operation 830, the CPU can work on other tasks until it is time for operation 835, which includes atomic operation 3.

At operation 835, the audio device 301 performs atomic operation 3 to achieve event synchronization. The first part of atomic operation 3 is the last operation in the coarse synchronization to synchronize local timers. Atomic operation 3 is created by the timeout of the periodic timer configured in atomic operation 2. Once the callback function obtains the CPU, the second part of this operation starts and decouples event synchronization from the timeout event. Atomic operation 3 captures TSF Clock values immediately and generates synchronized events at the qualified time. The execution of atomic operation 3 is set at every timeout of the periodic timer.

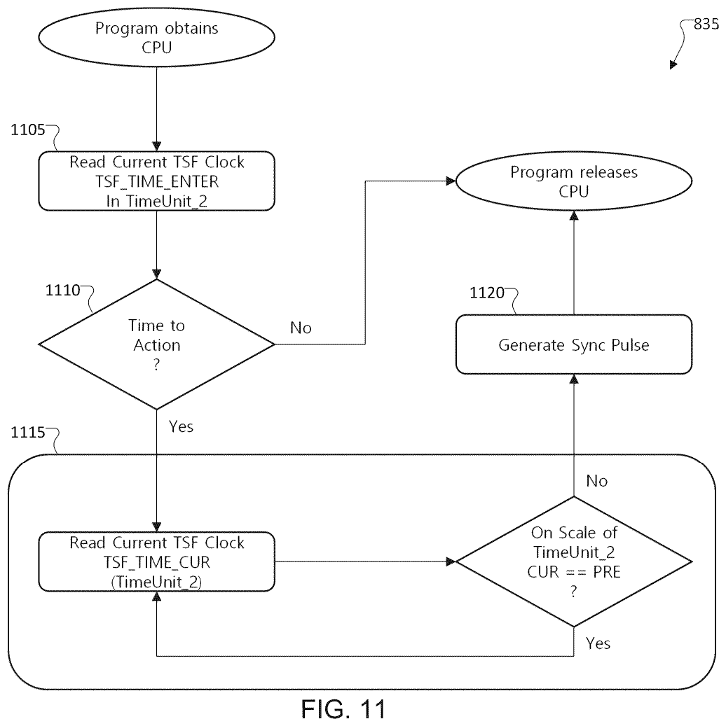

FIG. 11 illustrates a block diagram showing further details of operation 835 according to various embodiments of the present disclosure. As shown in FIG. 11, atomic operation 3 includes step 1105, in which the audio device 301 reads the current TSF clock in TimeUnit_2 as TSF_TIME_ENTER.

At step 1110, the audio device 301 checks if the current time is the time to generate a synchronization pulse. If it is not the time, the audio device 301 returns to operation 810. If it is time to generate a synchronization pulse, then the process moves to step 1115.

At step 1115, the audio device 301 reads the current TSF clock in TimeUnit_2, TSF_TIME_CUR, in a loop until TSF_TIME_CUR is greater than TSF_TIME_ENTER. Then, at step 1120, the audio device 301 generates the desired synchronization pulse.

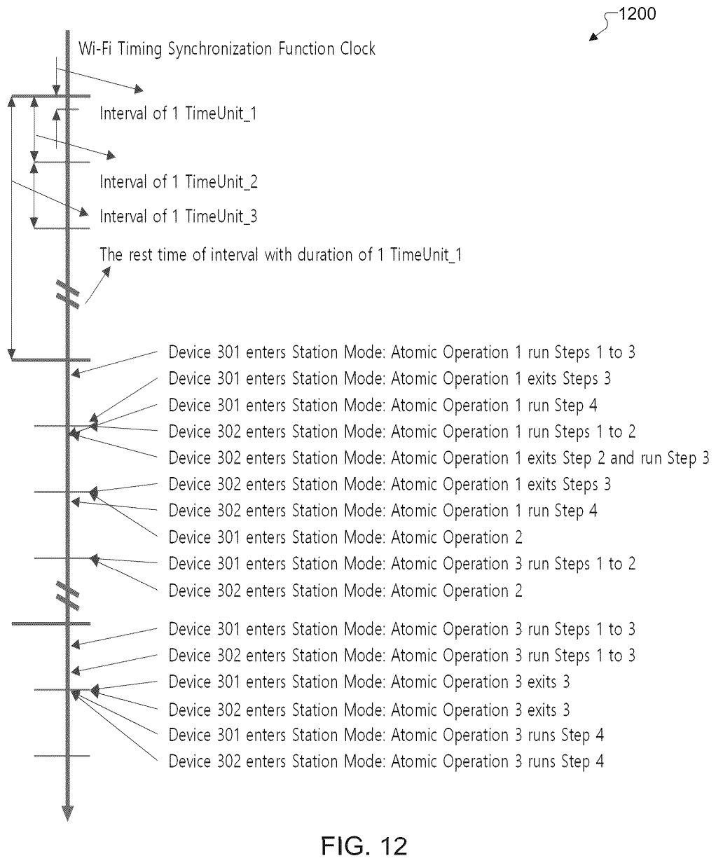

FIG. 12 illustrates an example workflow diagram of a wireless event synchronization process 1200 using two devices according to various embodiments of the present disclosure. Specifically, the workflow diagram depicts an analysis of atomic operations 1-3 in the time domain. The embodiment of the process 1200 shown in FIG. 12 is for illustration only. Other embodiments of the process 1200 could be used without departing from the scope of this disclosure. For ease of explanation, the process 1200 will be described as being implemented by the audio devices 301 and 302 of FIG. 3. However, the process 1200 could be implemented using any other suitable device or system.

As shown in FIG. 12, audio devices 301 and 302 enter Wi-Fi Station mode at different times. Atomic operations 1 and 2 are only executed once, and atomic operation 3 is executed with an interval of TimeUnit_2 after configuration is completed by atomic operation 2. Event synchronization is only triggered after decoupling is conducted at the designated time with an interval of TimeUnit_3. Here, TimeUnit_1 is microseconds, TimeUnit_2 is milliseconds, and TimeUnit_3 is the qualification time required by atomic operation 3 Step 2. The loops in the operations hold the step until the corresponding qualification events.

In the process 1200, the atomic operations 1-3 are the same as, or similar to, the atomic operations 1-3 shown in FIGS. 8 through 11. Additional details of atomic operations 1-3 for the process 1200 are shown below:

Atomic Operation 1: CPU Synchronized with TimeUnit_2

Schedule: The execution of this operation is expected with intervals close to TimeUnit_3.

### Detailed Steps:

1. Read the current TSF clock in TimeUnit_1 as TSF_TIME_CUR.

2. Read the current TSF clock in TimeUnit_1 and keep the previous reading as TSF_TIME_PRE in a loop until TSF_TIME_CUR is equal to TSF_TIME_PREV at a scale of TimeUnit_2 (Note: This step is optional).

3. Read the current TSF clock in TimeUnit_1 and keep the previous reading as TSF_TIME_PRE in a loop until TSF_TIME_CUR is not equal to TSF_TIME_PREV at a scale of TimeUnit_2. At this point, MOD(TSF_TIME_CUR, 1 TimeUnit_2) is close to 0, and there is enough time to complete the following step.

4. Set a trigger from the one-shot timer with timeout of (1 TimeUnit_2−MOD(TSF_TIME_CUR, 1 TimeUnit_2)+Adjustment_x).

Atomic Operation 2: CPU Synchronized with TimeUnit_1

Schedule: The execution of this operation is expected at the timeout of the one-shot timer started by atomic operation 1.

### Detailed Step:

1. Start or restart a trigger from the periodic timer with a timeout of (TimeUnit_2+Adjustment_y).

Atomic Operation 3: CPU Synchronized with TimeUnit_1

Schedule: The execution of this operation is expected at the timeout of the periodic timer started or restarted by atomic operation 2.

### Detailed Steps:

1. Read the current TSF clock in TimeUnit_2 as TSF_TIME_ENTER.

2. Check if this is the time to generate a synchronization pulse; if not, return.

3. Read the current TSF clock in TimeUnit_2, TSF_TIME_CUR, in a loop until TSF_TIME_CUR is greater than TSF_TIME_ENTER.

4. Generate the desired synchronization pulse.

From FIG. 12, it can be seen that the devices 301 and 302 perform a one-time coarse synchronization based on a time of the timer measured in TimeUnit_2, and then perform multiple periodic coarse synchronizations at first periodic time intervals after the one-time coarse synchronization operation. The devices 301 and 302 perform multiple fine synchronizations at second periodic time intervals between consecutive instances of the coarse synchronization.

It is noted that the processes disclosed above (such as the process 800 and the process 1200) are described as being implemented in software. However, the disclosed approaches can also be generalized into a hardware implementation. A hardware accelerator can be built to conserve CPU time. The use of the accelerator can be effective as long as the conditions shown below in List 2 are met. The implementation is similar to the software solution.

### List 2

Access to clocks that are capable of the Wi-Fi Time Synchronization Function, called TSF Clock.
Configurable hardware reading the TSF Clock with an execution time on the scale of TimeUnit_1.
Timers capable of triggering one-shot and periodic events with a resolution of TimeUnit_1 and a range greater than the scale of TimeUnit_2.
Configurable event trigger allowing either software or hardware deciding time to action.
Hardware event trigger system to generate a lumped compensation for previous latencies and then trigger the synchronization pulse directly.
Trigger distribution system allowing the synchronization pulse to directly trigger I/O and streaming mechanisms.

Although FIGS. 4 through 12 illustrate example techniques for time synchronization across wireless devices and related details, various changes may be made to FIGS. 4 through 12. For example, various components in FIGS. 4 through 12 could be combined, further subdivided, or omitted and additional components could be added according to particular needs. In addition, while shown as a series of steps, various operations in FIGS. 4 through 12 could overlap, occur in parallel, occur in a different order, or occur any number of times. In another example, steps may be omitted or replaced by other steps.

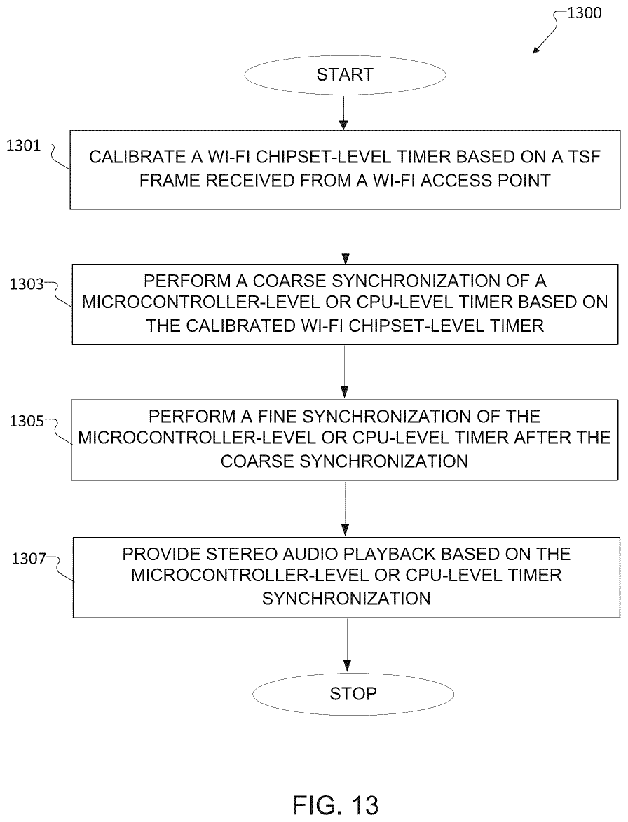

FIG. 13 illustrates a flow chart of a method 1300 for time synchronization across wireless devices according to various embodiments of the present disclosure, as may be performed by one or more components of the system 300 (e.g., the audio device 301), which may represent one or more components of the wireless network 100 (e.g., one or more STAs 111). The embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins at step 1301. At step 1301, a wireless device calibrates a Wi-Fi chipset-level timer based on a TSF frame received from a Wi-Fi access point. This could include, for example, the audio device 301 calibrating a TSF timer 520, such as shown in FIGS. 4 through 6.

At step 1303, the wireless device performs a coarse synchronization of a microcontroller-level or CPU-level timer based on the calibrated Wi-Fi chipset-level timer. This could include, for example, the audio device 301 performing the coarse synchronization operation 710 of FIG. 7 or the coarse synchronization in the process 800 of FIG. 8.

At step 1305, the wireless device performs a fine synchronization of the microcontroller-level or CPU-level timer after the coarse synchronization. Here, the fine synchronization is performed according to a first time scale measured in first time units and the coarse synchronization is performed according to a second time scale measured in second time units that are a multiple of the first time units. This could include, for example, the audio device 301 performing the fine synchronization operation 715 of FIG. 7 or the fine synchronization in the process 800 of FIG. 8.

At step 1307, the wireless device (and optionally one or more additional audio devices) provide stereo audio playback based on the microcontroller-level or CPU-level timer synchronization. This could include, for example, the audio device 301 (and optionally one or more of the audio devices 302 and 303) providing stereo audio playback after synchronization.

Although FIG. 13 illustrates one example of a method 1300 for time synchronization across wireless devices, various changes may be made to FIG. 13. For example, while shown as a series of steps, various steps in FIG. 13 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
calibrating, at a wireless device, a wireless fidelity (Wi-Fi) chipset-level timer based on a time synchronization function (TSF) frame received from a Wi-Fi access point;
performing, at the wireless device, a coarse synchronization of a microcontroller-level or CPU-level timer based on the calibrated Wi-Fi chipset-level timer; and
performing, at the wireless device, a fine synchronization of the microcontroller-level or CPU-level timer after the coarse synchronization,
wherein the fine synchronization is performed according to a first time scale measured in first time units and the coarse synchronization is performed according to a second time scale measured in second time units that are a multiple of the first time units.

2. The method of claim 1, wherein the calibration of the Wi-Fi chipset-level timer is based on a user datagram protocol (UDP) packet or a register reading.

3. The method of claim 1, wherein the coarse synchronization of the microcontroller-level or CPU-level timer utilizes a sleep function and the fine synchronization of the microcontroller-level or CPU-level timer utilizes an iterative algorithm.

4. The method of claim 1, wherein performing the coarse synchronization of the microcontroller-level or CPU-level timer comprises:
performing a one-time coarse synchronization operation based on a time of the calibrated Wi-Fi chipset-level timer measured in the second time units; and
performing multiple periodic coarse synchronization operations at first periodic time intervals after the one-time coarse synchronization operation,
wherein the first periodic time intervals are measured in the second time units.

5. The method of claim 4, wherein performing the fine synchronization of the microcontroller-level or CPU-level timer comprises:
performing multiple periodic fine synchronization operations at second periodic time intervals between consecutive instances of the multiple periodic coarse synchronization operations,
wherein the second periodic time intervals are measured in the first time units.

6. The method of claim 1, wherein:
the wireless device comprises an audio device; and
the method further comprises:
providing stereo audio playback using the wireless device and a second audio device based on the microcontroller-level or CPU-level timer synchronization.

7. The method of claim 1, wherein:
the first time scale is measured in microseconds; and
the second time scale is measured in milliseconds.

8. A device comprising:
a transceiver; and
a processor operably connected to the transceiver, the processor configured to:
calibrate a wireless fidelity (Wi-Fi) chipset-level timer based on a time synchronization function (TSF) frame received from a Wi-Fi access point;
perform a coarse synchronization of a microcontroller-level or CPU-level timer based on the calibrated Wi-Fi chipset-level timer; and
perform a fine synchronization of the microcontroller-level or CPU-level timer after the coarse synchronization,
wherein the processor is configured to perform the fine synchronization according to a first time scale measured in first time units and perform the coarse synchronization according to a second time scale measured in second time units that are a multiple of the first time units.

9. The device of claim 8, wherein the calibration of the Wi-Fi chipset-level timer is based on a user datagram protocol (UDP) packet or a register reading.

10. The device of claim 8, wherein the coarse synchronization of the microcontroller-level or CPU-level timer utilizes a sleep function and the fine synchronization of the microcontroller-level or CPU-level timer utilizes an iterative algorithm.

11. The device of claim 8, wherein to perform the coarse synchronization of the microcontroller-level or CPU-level timer, the processor is configured to:
perform a one-time coarse synchronization operation based on a time of the calibrated Wi-Fi chipset-level timer measured in the second time units; and
perform multiple periodic coarse synchronization operations at first periodic time intervals after the one-time coarse synchronization operation,
wherein the first periodic time intervals are measured in the second time units.

12. The device of claim 11, wherein to perform the fine synchronization of the microcontroller-level or CPU-level timer, the processor is configured to:
perform multiple periodic fine synchronization operations at second periodic time intervals between consecutive instances of the multiple periodic coarse synchronization operations,
wherein the second periodic time intervals are measured in the first time units.

13. The device of claim 8, wherein:
the device comprises an audio device; and
the processor is further configured to provide stereo audio playback using the device and a second audio device based on the microcontroller-level or CPU-level timer synchronization.

14. The device of claim 8, wherein:
the first time scale is measured in microseconds; and
the second time scale is measured in milliseconds.

15. The device of claim 8, wherein the processor comprises a hardware accelerator.

16. A non-transitory computer readable medium comprising program code that, when executed by a processor of a device, causes the device to:
calibrate a wireless fidelity (Wi-Fi) chipset-level timer based on a time synchronization function (TSF) frame received from a Wi-Fi access point;
perform a coarse synchronization of a microcontroller-level or CPU-level timer based on the calibrated Wi-Fi chipset-level timer; and
perform a fine synchronization of the microcontroller-level or CPU-level timer after the coarse synchronization,
wherein the program code causes the device to perform the fine synchronization according to a first time scale measured in first time units and perform the coarse synchronization according to a second time scale measured in second time units that are a multiple of the first time units.

17. The non-transitory computer readable medium of claim 16, wherein the calibration of the Wi-Fi chipset-level timer is based on a user datagram protocol (UDP) packet or a register reading.

18. The non-transitory computer readable medium of claim 16, wherein the coarse synchronization of the microcontroller-level or CPU-level timer utilizes a sleep function and the fine synchronization of the microcontroller-level or CPU-level timer utilizes an iterative algorithm.

19. The non-transitory computer readable medium of claim 16, wherein the program code to perform the coarse synchronization of the microcontroller-level or CPU-level timer comprises program code to:
perform a one-time coarse synchronization operation based on a time of the calibrated Wi-Fi chipset-level timer measured in the second time units; and
perform multiple periodic coarse synchronization operations at first periodic time intervals after the one-time coarse synchronization operation,
wherein the first periodic time intervals are measured in the second time units.

20. The non-transitory computer readable medium of claim 19, wherein the program code to perform the fine synchronization of the microcontroller-level or CPU-level timer comprises program code to:
perform multiple periodic fine synchronization operations at second periodic time intervals between consecutive instances of the multiple periodic coarse synchronization operations,
wherein the second periodic time intervals are measured in the first time units.

21. The non-transitory computer readable medium of claim 16, wherein:
the device comprises an audio device; and
the program code further causes the device to provide stereo audio playback using the device and a second audio device based on the microcontroller-level or CPU-level timer synchronization.
